(19) United States
(12) Patent Application Publication
(10) Pub. No.: US 2019/0283754 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Akihiro Toda, Wako-shi (JP)

(21) Appl. No.: 16/299,270

(22) Filed: Mar. 12, 2019

(30) Foreign Application Priority Data
Mar. 15, 2018 (JP) 2018-047995

(51) Int. Cl. B60W 30/18; G06K 9/00; B60W 30/165; B60W 30/16; G05D 1/00

(52) U.S. Cl. CPC B60W 30/18018; G06K 9/00825; B60W 2550/302; B60W 30/162; G05D 1/0088; B60W 30/165

(57) ABSTRACT

A vehicle control device (100) includes a recognizer (130) that is configured to recognize a surrounding situation of a subject vehicle, and a driving controller (140, 160) that is configured to control acceleration and deceleration and steering of the subject vehicle according to the surrounding situation recognized by the recognizer, and the driving controller is configured to determine whether or not the other vehicle recognized by the recognizer enters a lane in which the subject vehicle travels, and is configured to execute driving control for permitting entry of the other vehicle according to a state of acceleration and deceleration control of the subject vehicle when the driving controller determines that the other vehicle has entered the lane in which the subject vehicle travels.

### CROSS-REFERENCE TO RELATED APPLICATION

Priority is claimed on Japanese Patent Application No. 2018-047995, filed Mar. 15, 2018, the content of which is incorporated herein by reference.

### BACKGROUND

### Field of the Invention

The present invention relates to a vehicle control device, a vehicle control method, and a storage medium.

### Description of Related Art

In recent years, research on automatic vehicle control has been proceeding. In relation thereto, a technology for performing control for stopping a subject vehicle in front of an obstacle according to a positional relationship between the obstacle and another vehicle when the obstacle and the other vehicle are detected has been disclosed (for example, Japanese Unexamined Patent Application, First Publication No. 2015-64747).

### SUMMARY

However, in the related art, a control situation of the subject vehicle at the time of recognizing the other vehicle has not been considered. Therefore, the subject vehicle may not be able to be traveled smoothly.

The present invention has been made in consideration of such circumstances, and an object of the present invention is to provide a vehicle control device, a vehicle control method, and a storage medium capable of causing a subject vehicle to travel more smoothly.

(1) A vehicle control device according to one aspect of the present invention includes: a recognizer that is configured to recognize a surrounding situation of a subject vehicle; and a driving controller that is configured to control acceleration, deceleration and steering of the subject vehicle according to the surrounding situation recognized by the recognizer, wherein the driving controller is configured to determine whether or not another vehicle recognized by the recognizer enters a lane in which the subject vehicle travels, and is configured to execute driving control for permitting entry of the other vehicle according to a state of acceleration and deceleration control of the subject vehicle when the driving controller determines that the other vehicle has entered the lane in which the subject vehicle travels.

(2) In the aspect (1), the driving controller may execute driving control for permitting entry of the other vehicle when the recognizer recognizes the other vehicle entering the lane in which the subject vehicle travels during execution of the deceleration control of the subject vehicle.

(3) In the aspect (2), the deceleration control of the subject vehicle may include deceleration control according to following traveling control for following a preceding vehicle of the subject vehicle.

(4) In the aspects (1) to (3), when the recognizer recognizes the other vehicle entering the lane in which the subject vehicle travels in a state in which the subject vehicle is stopped, the driving controller may continue the stopped state.

(5) In the aspects (1) to (4), the driving controller may determine that the other vehicle recognized by the recognizer enters the lane in which the subject vehicle travels, and may not execute the driving control for permitting entry of the other vehicle when neither deceleration control nor stop control of the subject vehicle is executed.

(6) A vehicle control method according to one aspect of the present invention is a vehicle control method including: recognizing a surrounding situation of a subject vehicle; controlling acceleration, deceleration and steering of the subject vehicle according to the recognized surrounding situation; and determining whether or not a recognized other vehicle has entered a lane in which the subject vehicle travels, and executing driving control for permitting entry of the other vehicle according to a state of acceleration and deceleration control of the subject vehicle when it is determined that the other vehicle has entered the lane in which the subject vehicle travels.

(7) A computer readable non-transitory storage medium causing a vehicle control device to: recognize a surrounding situation of a subject vehicle; control acceleration, deceleration and steering of the subject vehicle according to the recognized surrounding situation; and determine whether or not a recognized other vehicle has entered a lane in which the subject vehicle travels, and execute driving control for permitting entry of the other vehicle according to a state of acceleration and deceleration control of the subject vehicle when it is determined that the other vehicle has entered the lane in which the subject vehicle travels.

According to (1) to (7), it is possible to cause the subject vehicle to travel more smoothly.

### BRIEF DESCRIPTION OF THE DRAWINGS

FIG. 1 is a configuration diagram of a vehicle system using a vehicle control device according to an embodiment.

FIG. 2 is a functional configuration diagram of a first controller, a second controller, and a notification controller.

FIG. 3 is a diagram showing processes of a surrounding environment recognizer and a specific other vehicle determiner.

FIG. 4 is a diagram showing a process of an entry permission controller.

FIG. 5 is a diagram showing a process of the entry permission controller that permits a specific other vehicle to enter a lane.

FIG. 6 is a diagram showing a process of the entry permission controller in a stopped state of a subject vehicle.

FIG. 7 is a diagram showing an example of a process of an avoidance driving controller.

FIG. 8 is a flowchart showing a flow of a process that is executed by the automated driving control device according to the embodiment.

FIG. 9 is a diagram showing an example of a hardware configuration of an automated driving control device according to an embodiment.

### DESCRIPTION OF EMBODIMENTS

Embodiments of a vehicle control device, a vehicle control method, and a storage medium according to the present invention will be described below with reference to the drawings. Further, a case in which left-hand driving is applied will be described below, but the right and the left may be reversed when right-hand driving is applied.

[Overall Configuration]

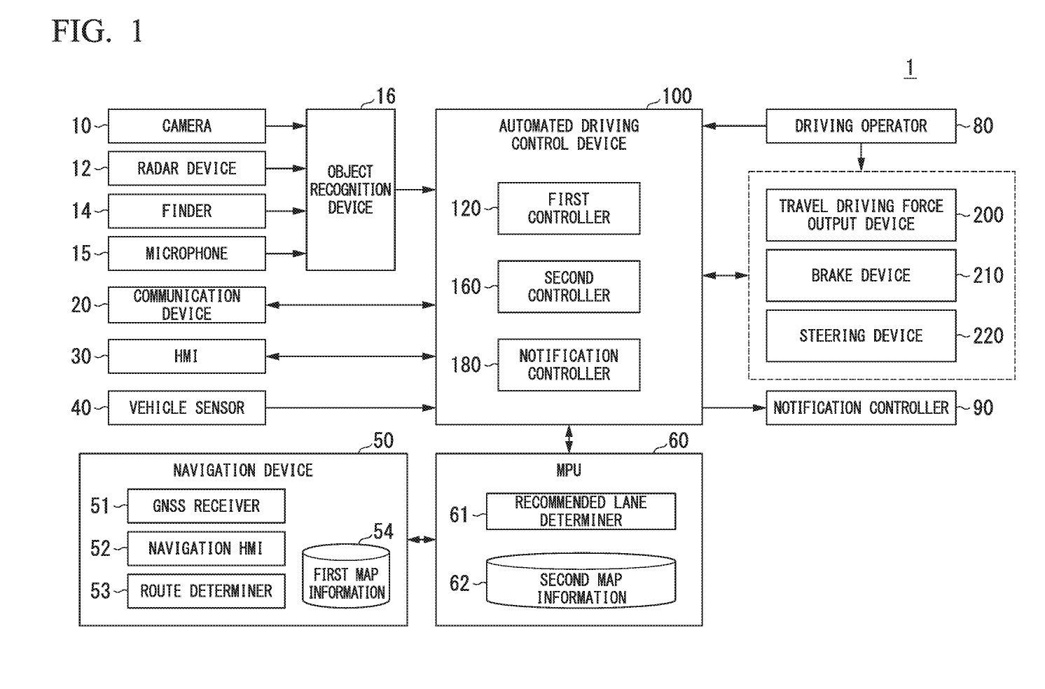

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle. A driving source thereof is an internal combustion engine such as a diesel engine or a gasoline engine, an electric motor, or a combination thereof. The electric motor operates using power generated by a power generator connected to the internal combustion engine, or discharge power of a secondary battery or a fuel cell.

The vehicle system 1 includes, for example, a camera 10, a radar device 12, a finder 14, a microphone 15, an object recognition device 16, a communication device 20, a human machine interface (HMI) 30, a vehicle sensor 40, a navigation device 50, a map positioning unit (MPU) 60, a driving operator 80, a notification controller 90, an automated driving control device 100, a travel driving force output device 200, a brake device 210, and a steering device 220. These units or devices are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added. The automated driving control device 100 is an example of the “vehicle control device” The camera 10 is, for example, a digital camera using a solid-state imaging device such as a charge coupled device (CCD) or a complementary metal oxide semiconductor (CMOS). The camera 10 is attached to any place on the vehicle in which the vehicle system 1 is mounted (hereinafter referred to as a subject vehicle M). In the case of forward imaging, the camera 10 is attached to an upper portion of a front windshield, a rear surface of a rearview mirror, or the like. The camera 10, for example, periodically repeatedly images the periphery of the subject vehicle M. The camera 10 may be a stereo camera.

The radar device 12 radiates radio waves such as millimeter waves to the surroundings of the subject vehicle M and detects radio waves (reflected waves) reflected by an object to detect at least a position (a distance and orientation) of the object. The radar device 12 is attached to any place on the subject vehicle M. The radar device 12 may detect a position and a speed of the object using a frequency modulated continuous wave (FM-CW) scheme.

The finder 14 is a light detection and ranging (LIDAR). The finder 14 radiates light around the subject vehicle M and measures scattered light. The finder 14 detects a distance to a target according to a time from light emission to light reception. The radiated light is, for example, pulsed laser light. The finder 14 is attached to any place on the subject vehicle M. The microphone 15 collects sound around the subject vehicle M. The microphone 15 is attached to any place on the subject vehicle M.

The object recognition device 16 performs a sensor fusion process on detection results of some or all of the camera 10, the radar device 12, the finder 14, and the microphone 15 to recognize a position, type, speed, and the like of the object. The object recognition device 16 outputs recognition results to the automated driving control device 100. The object recognition device 16 may output the detection results of the camera 10, the radar device 12, or the finder 14 to the automated driving control device 100 as they are. The object recognition device 16 may be omitted from the vehicle system 1. The camera 10 includes an infrared camera that images a change in a surface temperature of the object, in addition to capturing of normal images. The camera 10 may be switched between normal imaging and infrared imaging by a function provided in the camera 10.

The communication device 20, for example, communicates with another vehicle near the subject vehicle M using a cellular network, a Wi-Fi network, Bluetooth (registered trademark), dedicated short range communication (DSRC), or the like or communicates with various server devices via a wireless base station.

The HMI 30 presents various types of information to an occupant of the subject vehicle M and receives an input operation from the occupant. The HMI 30 includes various display devices, speakers, buzzers, touch panels, switches, keys, and the like.

The vehicle sensor 40 includes, for example, a vehicle speed sensor that detects a speed of the subject vehicle M, an acceleration sensor that detects an acceleration, a yaw rate sensor that detects an angular speed around a vertical axis, and an orientation sensor that detects the direction of the subject vehicle M.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 specifies a position of the subject vehicle M according to a signal received from a GNSS satellite. The position of the subject vehicle M may be specified or supplemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. The route determiner 53, for example, determines a route (hereinafter, an on-map route) from the position of the subject vehicle M (or any input position) specified by the GNSS receiver 51 to a destination input by the occupant using the navigation HMI 52 by referring to the first map information 54. The first map information 54 is, for example, information in which a road shape is represented by links indicating roads and nodes connected by the links. The first map information 54 may include a curvature of the road, point of interest (POI) information, and the like. The on-map route is output to the MPU 60. The navigation device 50 may perform route guidance using the navigation HMI 52 according to the on-map route. The navigation device 50 may be realized, for example, by a function of a terminal device such as a smartphone or a tablet terminal possessed by the occupant. The navigation device 50 may transmit a current position and a destination to a navigation server via the communication device 20 and acquire the same route as the on-map route from the navigation server.

The MPU 60 includes, for example, a recommended lane determiner 61, and holds second map information 62 in a storage device such as an HDD or a flash memory.

The recommended lane determiner 61 divides the on-map route provided from the navigation device 50 into a plurality of blocks (for example, divides the route every 100 [m] in a progression direction of the vehicle), and determines a recommended lane for each block by referring to the second map information 62. The recommended lane determiner 61 determines in which lane from the left the subject vehicle M travels. The recommended lane determiner 61 determines the recommended lane so that the subject vehicle M can travel on a reasonable route for progression to a branch destination when there is a branch place in the on-map route.

The second map information 62 is map information with higher accuracy than the first map information 54. The second map information 62 includes, for example, information on a center of the lane or information on a boundary of the lane. The second map information 62 may include road information, traffic regulation information, address information (an address and postal code), facility information, telephone number information, and the like. The second map information 62 may be updated at any time by the communication device 20 communicating with another device.

The driving operator 80 includes, for example, an accelerator pedal, a brake pedal, a shift lever, a steering wheel, a modified steering wheel, a joystick, and other operators. A sensor that detects the amount of operation or the presence or absence of the operation is attached to the driving operator 80, and a result of the detection is output to some or all of the automated driving control device 100, the travel driving force output device 200, the brake device 210, and the steering device 220.

The notification controller 90 includes, for example, a headlight, a horn, a speaker for outside of the vehicle, and a display device for outside of the vehicle. The notification controller 90, for example, outputs information such as light, sound, an image, or a message to the surroundings of the subject vehicle M using at least one of the above-described devices according to control content of the notification controller 180.

The automated driving control device 100 includes, for example, a first controller 120, a second controller 160, and the notification controller 180. Each of these components is realized, for example, by a hardware processor such as a central processing unit (CPU) executing a program (software). Some or all of these components may be realized by hardware (including circuitry) such as a large scale integration (LSI), an application specific integrated circuit (ASIC), a field-programmable gate array (FPGA), or a graphics processing unit (GPU) or may be realized by software and hardware in cooperation. The program may be stored in a storage device such as an HDD or a flash memory of the automated driving control device 100 in advance or may be stored in a removable storage medium such as a DVD or a CD-ROM and the storage medium may be mounted in a drive device so that the program may be installed in the HDD or the flash memory of the automated driving control device 100. A combination of the action plan generator 140 and the second controller 160 is an example of the “driving controller”.

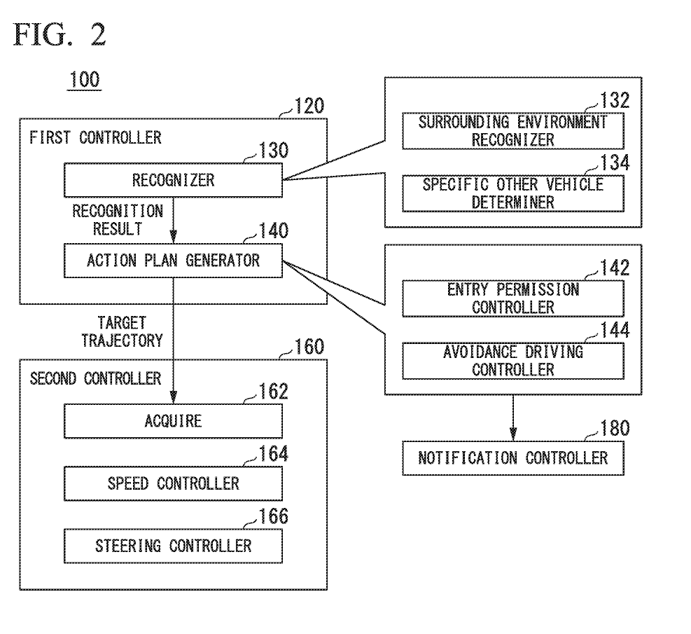

FIG. 2 is a functional configuration diagram of the first controller 120, the second controller 160, and the notification controller 180. The first controller 120 includes, for example, a recognizer 130 and an action plan generator 140. The first controller 120 realizes, for example, a function according to artificial intelligence (AI) and a function according to a previously given model in parallel. For example, in a function of “recognizing an intersection,” recognition of the intersection using deep learning or the like and recognition according to previously given conditions (a signal which can be subjected to pattern matching, a road sign, or the like) are executed in parallel, and the function of recognizing an intersection is realized by scoring both recognitions and comprehensively evaluating the recognitions. Accordingly, the reliability of automated driving is guaranteed.

The recognizer 130 recognizes a state such as a position, direction, speed or acceleration of an object near the subject vehicle M according to information input from the camera 10, the radar device 12, and the finder 14 via the object recognition device 16. Examples of the object include a moving body such as a pedestrian or another vehicle, or an obstacle such as a construction place. The position of the object, for example, is recognized as a position at absolute coordinates with a representative point (a centroid, a drive shaft center, or the like) of the subject vehicle M as an origin, and is used for control. The position of the object may be represented by a representative point such as a centroid or a corner of the object or may be represented by a represented area. The “state” of the object may include an acceleration or jerk of the object, or an “action state” (for example, whether or not the object is changing lanes or is about to change lanes).

The recognizer 130 recognizes a lane (traveling lane) in which the subject vehicle M is traveling. For example, the recognizer 130 compares a pattern of a road marking line (for example, an arrangement of a solid line and a broken line) obtained from the second map information 62 with a pattern of a road marking line near the subject vehicle M recognized from the image captured by the camera 10 to recognize the traveling lane. The recognizer 130 may recognize not only the road marking lines but also a traveling road boundary (a road boundary) including the road marking line, a road shoulder, a curb, a median strip, a guard rail, or the like to recognize the traveling lane. In this recognition, the position of the subject vehicle M acquired from the navigation device 50 or a processing result of an INS may be added. The recognizer 130 may recognize a width, a height, a shape, or the like of an obstacle (for example, a width or a length of the other vehicle) according to the image captured by the camera 10. The recognizer 130 recognizes a sidewalk, a temporary stop line, an obstacle, a traffic light, a toll gate, a road structure, and other road events.

The recognizer 130 recognizes a position or a posture of the subject vehicle M relative to the traveling lane when recognizing the traveling lane. The recognizer 130 may recognize, for example, a deviation of a reference point of the subject vehicle M from a center of the lane, and an angle formed between a progression direction of the subject vehicle M and a line connecting a center of the lane as a relative position and a posture of the subject vehicle M with respect to the traveling lane. Instead, the recognizer 130 may recognize, for example, a position of the reference point of the subject vehicle M with respect to any one of side end portions (the road marking line or the road boundary) of the traveling lane as the relative position of the subject vehicle M with respect to the traveling lane. The recognizer 130 may recognize a structure (for example, a utility pole or a median strip) on the road according to the first map information 54 or the second map information 62. Functions of the surrounding environment recognizer 132 and the specific other vehicle determiner 134 of the recognizer 130 will be described below.

In principle, the action plan generator 140 generates a target trajectory along which the subject vehicle M will travel in the future automatically (without depending on an operation of a driver) so that the subject vehicle M can travel on the recommended lane determined by the recommended lane determiner 61 and cope with a surrounding situation of the subject vehicle M. The target trajectory includes, for example, a speed element. For example, the target trajectory is represented as a sequence of points (trajectory points) to be reached by the subject vehicle M. The trajectory point is a point that the subject vehicle M is to reach for each predetermined travel distance (for example, several meters) at a road distance, and a target speed and a target acceleration at every predetermined sampling time (for example, several tenths of a [sec]) are separately generated as part of the target trajectory. The trajectory point may be a position that the subject vehicle M is to reach at the sampling time at every predetermined sampling time. In this case, information on the target speed or the target acceleration is represented by the interval between the trajectory points.

When the action plan generator 140 generates the target trajectory, the action plan generator 140 may set an event of automated driving. Examples of the automated driving event include a constant speed traveling event, a low speed following driving event, a lane changing event, a branching event, a merging event, a takeover event, and an avoidance event. The action plan generator 140 generates a target trajectory according to an activated event. The functions of the entry permission controller 142 and the avoidance driving controller 144 of the action plan generator 140 will be described below.

The second controller 160 controls the travel driving force output device 200, the brake device 210, and the steering device 220 so that the subject vehicle M passes through the target trajectory generated by the action plan generator 140 at a scheduled time.

The second controller 160 includes, for example, an acquire 162, a speed controller 164, and a steering controller 166. The acquire 162 acquires information on the target trajectory (trajectory points) generated by the action plan generator 140 and stores the information on the target trajectory in a memory (not shown). The speed controller 164 controls the travel driving force output device 200 or the brake device 210 according to the speed element incidental to the target trajectory stored in the memory. The steering controller 166 controls the steering device 220 according to a degree of bend of the target trajectory stored in the memory. Processes of the speed controller 164 and the steering controller 166 are realized by, for example, a combination of feedforward control and feedback control. For example, the steering controller 166 executes a combination of feedforward control according to a curvature of a road in front of the subject vehicle M and feedback control according to a deviation from the target trajectory.

The notification controller 180 outputs information to the surroundings of the subject vehicle M using the notification controller 90. For example, when another vehicle present in front of the subject vehicle M and outside the lane in which the subject vehicle M travels is permitted to enter the lane, the notification controller 180 notifies the notification controller 90 of information indicating that the subject vehicle M permits the other vehicles to enter the lane. Details of a function of the notification controller 180 will be described below.

The travel driving force output device 200 outputs a travel driving force (torque) for traveling of the vehicle to the driving wheels. The travel driving force output device 200 includes, for example, a combination of an internal combustion engine, an electric motor, a transmission, and the like, and an ECU that controls these. The ECU controls the above configuration according to information input from the second controller 160 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the second controller 160 or information input from the driving operator 80 so that a brake torque according to a braking operation is output to each wheel. The brake device 210 may include a mechanism that transfers the hydraulic pressure generated by the operation of the brake pedal included in the driving operator 80 to the cylinder via a master cylinder as a backup. The brake device 210 is not limited to the configuration described above and may be an electronically controlled hydraulic brake device that controls the actuator according to information input from the second controller 160 and transfers the hydraulic pressure of the master cylinder to the cylinder.

The steering device 220 includes, for example, a steering ECU and an electric motor. The electric motor, for example, changes a direction of the steerable wheels by causing a force to act on a rack and pinion mechanism. The steering ECU drives the electric motor according to information input from the second controller 160 or information input from the driving operator 80 to change the direction of the steerable wheels.

[Function of Surrounding Environment Recognizes]

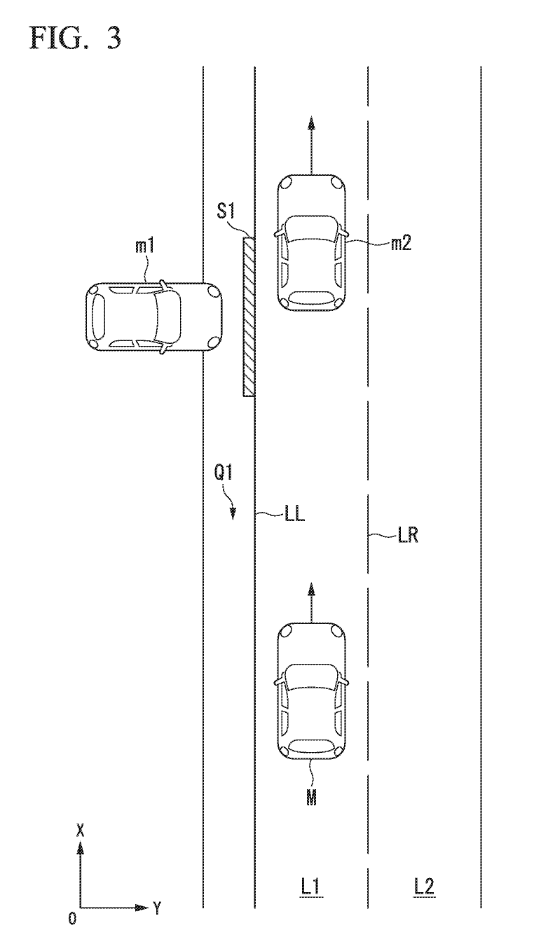

The surrounding environment recognizer 132 analyzes the image captured by the camera 10 to recognize the surrounding environment of the subject vehicle M according to luminance difference, pattern matching, and the like of the image. FIG. 3 is a diagram showing processes of the surrounding environment recognizer 132 and the specific other vehicle determiner 134. In the example of FIG. 3, it is assumed that a road in which the subject vehicle M can travel with two lanes in the same direction is shown, and the subject vehicle M is traveling in a lane L1 partitioned by road marking lines LL and LR.

For example, the surrounding environment recognizer 132 analyzes the image captured by the camera to recognize a road structure of the lane L1 in which the subject vehicle M travels and an area outside the lane. The area outside the lane includes, for example, an area in which adjacent lanes, opposite lanes, sidewalks, and an area in which other vehicles can travel. For example, the surrounding environment recognizer 132 recognizes a sidewalk Q1 as a region outside the lane adjacent to a road marking line LL on the left side of the lane L1. The surrounding environment recognizer 132 may recognize a curb provided between the lane L1 and the sidewalk Q1. The surrounding environment recognizer 132 recognizes a position of an entry road S1 in which the other vehicle can enter the lane L1 from the sidewalk Q1. An entry road S1 includes an entry road provided as a break of a curb between the sidewalk Q1 and the lane L1 or an entry road provided as a slope with a part of the curb being lower than the other part. The entry road S1 may be a slope additionally installed on the road side to be adjacent to the curb.

[Function of Specific Other Vehicle Determiner]

The specific other vehicle determiner 134 determines whether or not another vehicle present around the subject vehicle M recognized by the recognizer 130 is a specific other vehicle. The specific other vehicle is, for example, another vehicle which is present in front of the subject vehicle M and is estimated to be likely to enter the lane L1 from the outside of the lane L1 in which the subject vehicle M travels. Specifically, the specific other vehicle determiner 134 determines whether or not the other vehicle recognized by the recognizer 130 is the specific other vehicle according to a change in behavior or state that is an element of entry of the other vehicle into the lane L1. Hereinafter, some determination patterns will be described.

[Determination Pattern (1)]

For example, the specific other vehicle determiner 134 determines, as the specific other vehicle, the other vehicle that is present outside the lane L1 in which the subject vehicle M is traveling and that stops or slowly travels toward the lane L1 in a direction (for example, a road width direction of the lane L1; a Y direction in the drawing) substantially perpendicular to a progression direction of the subject vehicle M (for example, a direction in which the lane L1 extends; an X direction in the drawing) among the other vehicles present in front of the subject vehicle M. The specific other vehicle determiner 134 may determine another vehicle that stops in the progression direction of the subject vehicle M or another vehicle that stops in an oblique direction with respect to the progression direction of the subject vehicle M as the specific other vehicle.

[Determination Pattern (2)]

The specific other vehicle determiner 134, for example, acquires a heat generation region of the other vehicle that is present outside the lane L1 and stops in the direction substantially perpendicular to the progression direction of the subject vehicle M among the other vehicles present in front of the subject vehicle M according to a change in luminance of the image captured by an infrared camera or the like. For example, when the other vehicle is operated by an internal combustion engine, the heat generation region is the vicinity of a mounting position of the engine, an installation position of a muffler or a catalyst, or the like. The specific other vehicle determiner 134 determines whether or not an engine of the other vehicle is in operation according to the acquired heat generation area, and determines that the other vehicle is the specific other vehicle when it is determined that the other vehicle is in operation.

[Determination Pattern (3)]

The specific other vehicle determiner 134 acquires, for example, sound or vibration of the other vehicle that is present outside the lane L1 and stops in the direction substantially orthogonal to the progression direction of the subject vehicle M among the other vehicles present in front of the subject vehicle M. The specific other vehicle determiner 134, for example, extracts an engine sound or vibration sound such as idling generated by the other vehicle from data of the sound around the subject vehicle M collected by the microphone 15 through analysis using a fast Fourier transform (FFT). In addition to the engine sound of the other vehicle, the specific other vehicle determiner 134 may recognize an inverter sound emitted when a motor is driven, a voice warning such as “depart”, or the like. The specific other vehicle determiner 134 may recognize, for example, a direction of a sound source of the extracted engine sound. The specific other vehicle determiner 134 determines whether or not the engine of the other vehicle is in operation according to the acquired sound or vibration. When it is determined that the other vehicle is in operation, the specific other vehicle determiner 134 recognizes that the other vehicle is the specific other vehicle.

[Determination Pattern (4)]

The specific other vehicle determiner 134, for example, acquires lighting (light emission) of a light or a blinker of the other vehicle that is present outside the lane L1 and stops or slowly travels in the direction substantially perpendicular to the progression direction of the subject vehicle M among the other vehicles present in front of the subject vehicle M according to an analysis result of the image captured by the camera 10. The specific other vehicle determiner 134 determines the other vehicle in which the light are lit (light is emitted) as the specific other vehicle.

[Determination Pattern (5)]

The specific other vehicle determiner 134, for example, generates a three-dimensional model indicating a relative positional relationship between the subject vehicle M and the other vehicle recognized at the position of the subject vehicle M at a certain point in time among the other vehicles present in front of the subject vehicle M. Then, the specific other vehicle determiner 134 compares a position in the model of the other vehicle on a three-dimensional space in which an appearance from the subject vehicle M has changed with a position in the image of the other vehicle that has already been acquired, after the progression to a certain extent, and determines that the other vehicle is the specific other vehicle when the other vehicle has acquired a behavior in which the other vehicle enters the lane L1 from the area outside the lane L1 or a progression direction.

Further, the specific other vehicle determiner 134 may also determine that the other vehicle m1 is the specific other vehicle when there is the entry road S1 recognized by the surrounding environment recognizer 132 in front of or a progression direction of the other vehicle m1 that stops or slows travels, in addition to the respective conditions of the determination patterns (1) to (5) described above. Accordingly, the specific other vehicle determiner 134 can determine the specific other vehicle more reliably. In the example of FIG. 3, the specific other vehicle determiner 134 determines that the other vehicle m1 among the other vehicles m1 and m2 present around the subject vehicle M is the specific other vehicle.

[Function of Entry Permission Controller]

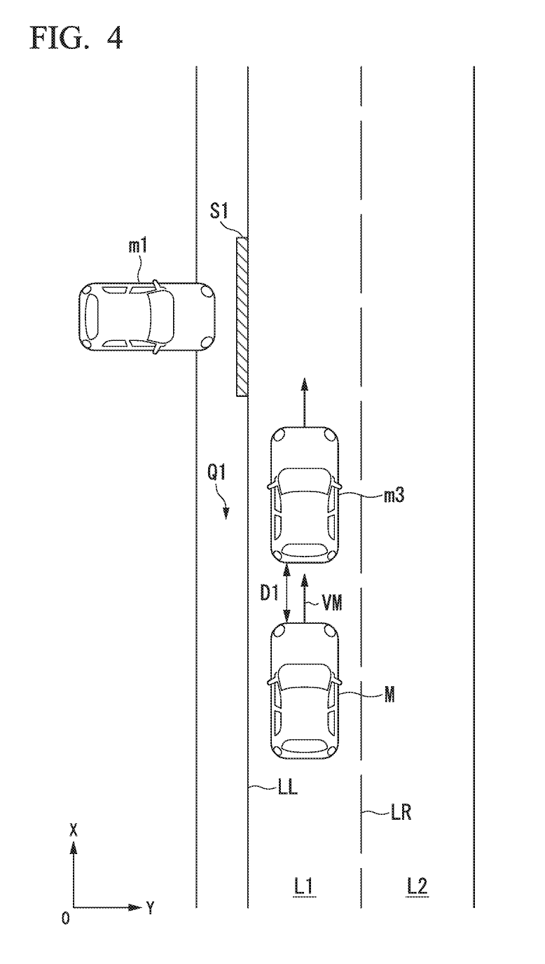

The entry permission controller 142 executes driving control regarding the entry of the specific other vehicle m1 into the lane L1 according to the state of acceleration and deceleration control of the subject vehicle. FIG. 4 is a diagram showing a process of the entry permission controller 142. In the example of FIG. 4, it is assumed that the subject vehicle M and the other vehicle m3 are traveling in the lane L1. In the example of FIG. 4, it is assumed that in the subject vehicle M, following traveling control such as adaptive cruise control System (ACC) or low speed following (LSF) is executed according to the event determined by the action plan generator 140. For example, in the following traveling control, the travel driving force output device 200 and the brake device 210 are controlled so that the subject vehicle M performs following travel in a state in which an inter-vehicle distance between the subject vehicle M and the other vehicle m3 that is a preceding vehicle is maintained to be constant according to information input from the camera 10, the radar device 12, or the finder 14 via the object recognition device 16. That is, in the following traveling control, acceleration and deceleration control of the subject vehicle M according to an inter-vehicle distance to the other vehicle m3 is performed.

In this case, when the specific other vehicle determiner 134 determines that there is the specific other vehicle, the entry permission controller 142 determines whether or not the speed control being executed by the speed controller 164 is deceleration control. The entry permission controller 142 may acquire an acceleration of the subject vehicle M acquired by the vehicle sensor 40 and determine whether or not the deceleration control is being performed according to the acquired acceleration. When the speed control being executed by the speed controller 164 is the deceleration control or when the acceleration of the subject vehicle M is a negative value (that is, a state in which the speed VM of the subject vehicle M is decreased), the entry permission controller 142 executes control for permitting the other vehicle m1 to enter the lane L1. The control for permitting the other vehicle m1 to enter the lane L1 is, for example, deceleration or stop of the subject vehicle M, and notification of the notification controller 90 to the other vehicle m1.

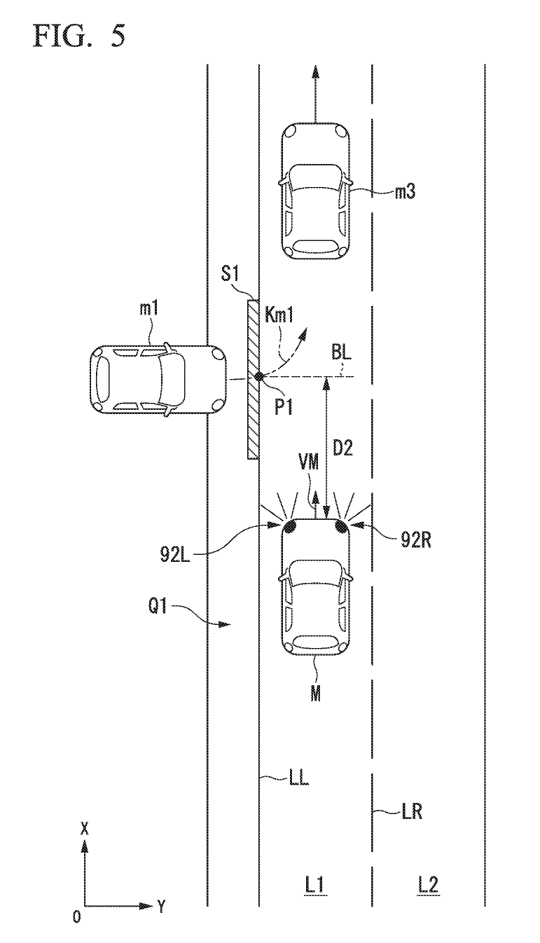

FIG. 5 is a diagram showing a process of the entry permission controller 142 that permits the specific other vehicle to enter the lane L1. In the example of FIG. 5, it is assumed that the entry permission controller 142 performs the deceleration control for causing the other vehicle M1 to enter the lane L1 and a notification using the notification controller 90. In this case, the entry permission controller 142 sets a degree of deceleration (an amount of deceleration per predetermined time) of the subject vehicle M to be higher than a degree of deceleration of the deceleration control at the time of the following traveling control. Accordingly, the entry permission controller 142 can increase the distance to the other vehicle m3.

The entry permission controller 142, for example, may increase the degree of deceleration according to a current speed VM of the subject vehicle M and may increase the degree of deceleration according to a distance D2 from a reference line BL according to a point P1 at which the other vehicle m1 is estimated to enter the lane L1 to a front end portion of the subject vehicle M. The point P1 at which the other vehicle m1 is estimated to enter the lane L1 is, for example, a point P1 at which an estimated trajectory Km1 when it is assumed that the other vehicle m1 has entered the lane L1 from the current position, and the road marking line LL intersect each other. The reference line BL is, for example, a straight line extending in a lateral direction of the lane L1 (a Y direction in the drawing) from the point P1. The distance D2, specifically, is a distance from a distal end portion of the subject vehicle M to the reference line BL extending in a direction in which the road extends (an X direction in the drawing).

When the distance D2 is equal to or longer than a predetermined distance or when the speed VM becomes equal to or lower than a predetermined speed, the entry permission controller 142 causes the notification controller 180 to execute a notification for permitting entry of another vehicle. The notification controller 180 causes the notification controller 90 to notify the other vehicle m1 of information indicating that the subject vehicle M permits entry according to an instruction from the entry permission controller 142. For example, in the example of FIG. 5, the notification controller 180 lights headlights 92L and 92R provided on the left and right of a distal end portion of the subject vehicle M as the notification controller 90 instantaneously upward (high beam) to perform passing, and performs a notification for prompting the other vehicle m1 to enter the lane L1. Instead of or in addition to the passing, the notification controller 180 may sound a horn of the notification controller 90 to perform a notification prompting the other vehicle m1 to enter the lane L1. The notification controller 180 may cause message information such as “after you” to be output as sound from the speaker for outside of the vehicle of the notification controller 90 as information for prompting the other vehicle m1 to enter the lane L1, or cause the message information to be displayed and output on the display device for outside of the vehicle. When inter-vehicle communication with the other vehicle m1 is possible via the communication device 20, the notification controller 180 may transmit information for prompting the other vehicle m1 to enter the lane L1 via the communication device 20.

When the specific other vehicle determiner 134 determines that there is the other vehicle m1 entering the lane L1 in which the subject vehicle M travels in a state in which the subject vehicle M is stopped according to the stop control, the entry permission controller 142 may execute driving control for causing the subject vehicle M to continue the stopped state. The stop control is, for example, a control for maintaining a state in which the speed VM of the subject vehicle M is zero (0) [km/h]. The stop control may include control for causing the subject vehicle M to slowly travel at about 10 [km/h] or less.

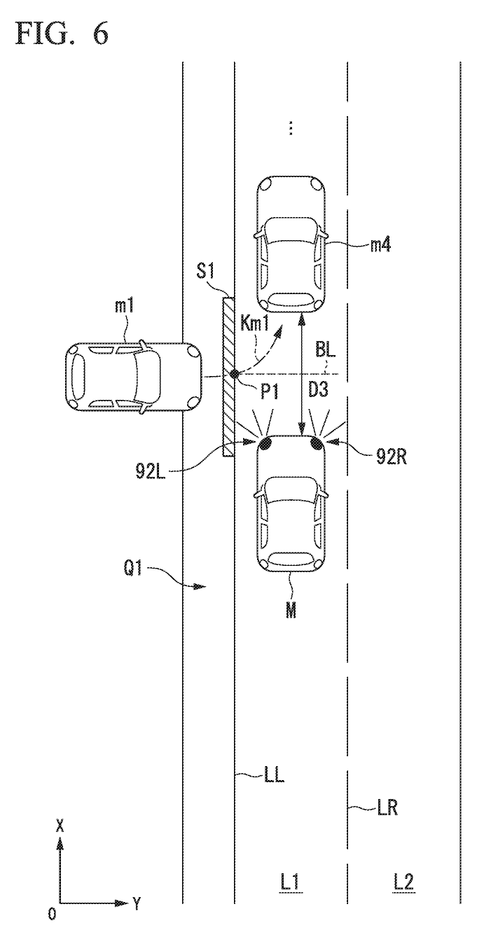

FIG. 6 is a diagram showing a process of the entry permission controller 142 in the stopped state of the subject vehicle M. In the example of FIG. 6, it is assumed that the lane L1 is congested and the subject vehicle M stops at an inter-vehicle distance of a distance D3 after the other vehicle m4. In the example of FIG. 6, it is assumed that the subject vehicle M stops at a position in front of the reference line BL.

In this state, in a case in which the other vehicle m1 entering the lane L1 from the front of the subject vehicle M is recognized, the entry permission controller 142 continues stop control even when the other vehicle m4 stopped at the front of the subject vehicle M has progressed. That is, even when the other vehicle m4 starts traveling forward, the entry permission controller 142 causes the subject vehicle M to continue to stop until the entry of the other vehicle m1 into the lane L1 is completed without causing the subject vehicle M to start traveling. The completion of entry of the other vehicle m1 into the lane L1 means, for example, that a predetermined area or more of an entire area (for example, a half or more of the entire area) of the other vehicle m1 is present within the area of the lane L1.

For example, when the following traveling control such as ACC or LSF is being executed by the action plan generator 140, the entry permission controller 142 stops the following traveling control and executes a driving control allowing the entry of the other vehicle m1. The entry permission controller 142 may execute traveling control for following the other vehicle m1 after the other vehicle m1 has entered the lane L1.

The notification controller 180, for example, may continue the stop control of the entry permission controller 142 to perform passing using the headlights 92L and 92R of the notification controller 90 when the distance D3 becomes the predetermined distance or more or to output sound from the speaker for outside of the vehicle, thereby performing control for prompting the other vehicle m1 to enter the lane L1. Here, the predetermined distance may be, for example, equal to or more than a distance (for example, about twice a vehicle length of the other vehicle m1) with reference to a vehicle length of the other vehicle m1 recognized by the recognizer 130, or may be a fixed distance.

In the acceleration and deceleration control when it is determined that the other vehicle m1 recognized by the specific other vehicle determiner 134 enters the lane L1 in which the subject vehicle M travels, the entry permission controller 142 does not execute the driving control for permitting the entry of the other vehicle m1 when deceleration control or stop control of the subject vehicle M is not executed (that is, when constant speed control or acceleration control is executed). In this case, the entry permission controller 142 continues the following traveling control such as ACC or LSF and follows the preceding vehicle.

[Function of Avoidance Driving Controller]

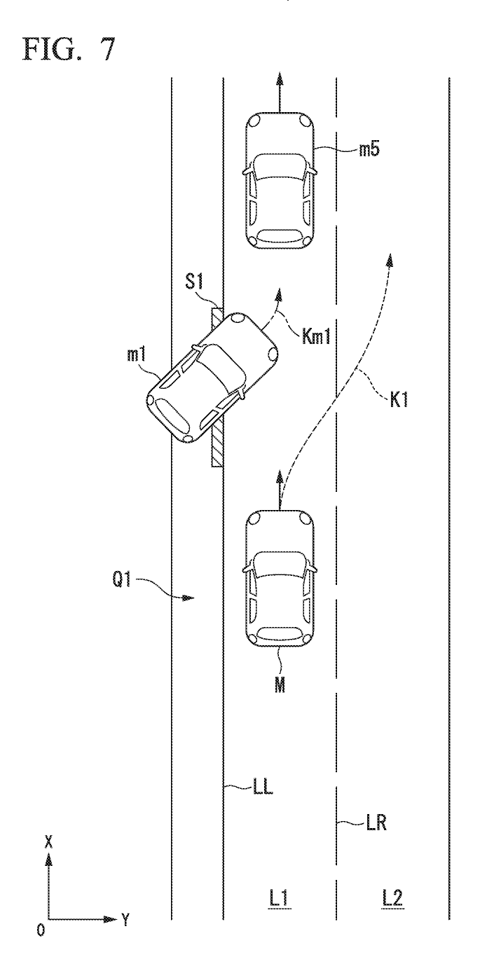

The avoidance driving controller 144 generates a target trajectory for avoiding contact with an object present around the subject vehicle M recognized by the recognizer 130. FIG. 7 is a diagram showing an example of a process of the avoidance driving controller 144. In the example of FIG. 7, it is assumed that the subject vehicle M continues traveling control for following another vehicle m5 traveling in the lane L1. In the example of FIG. 7, it is assumed that neither deceleration control nor stop control according to the following traveling control is executed for the subject vehicle M. In this case, even when the other vehicle m1 is recognized, the entry permission controller 142 does not execute the driving control for permitting the entry of the other vehicle m1. In this case, as shown in FIG. 7, when the other vehicle m1 enters the lane L1, the avoidance driving controller 144 executes contact avoidance control to avoid contact with the other vehicle m1. Specifically, the avoidance driving controller 144 generates a target trajectory K1 for avoiding contact with the other vehicle m1 according to position information of the other vehicle m1 or an estimated trajectory Km1 in which the other vehicle m1 is estimated to travel in the future. In the example of FIG. 7, the target trajectory K1 in which the subject vehicle M changes the lane to an adjacent lane L2 and travels is generated. The avoidance driving controller 144 may generate a target trajectory in which the subject vehicle M is caused to stop at a position at which the subject vehicle M does not contact the other vehicle m1 instead of or in addition to changing the lane.

When the subject vehicle M is caused to travel along the target trajectory K1 described above, the avoidance driving controller 144 may end the following traveling control that has been executed so far. Accordingly, it is possible to execute more appropriate driving control even when the other vehicle m1 has entered in a state in which the driving control for permitting the entry of the other vehicle m1 is not executed.

[Flow of Process]

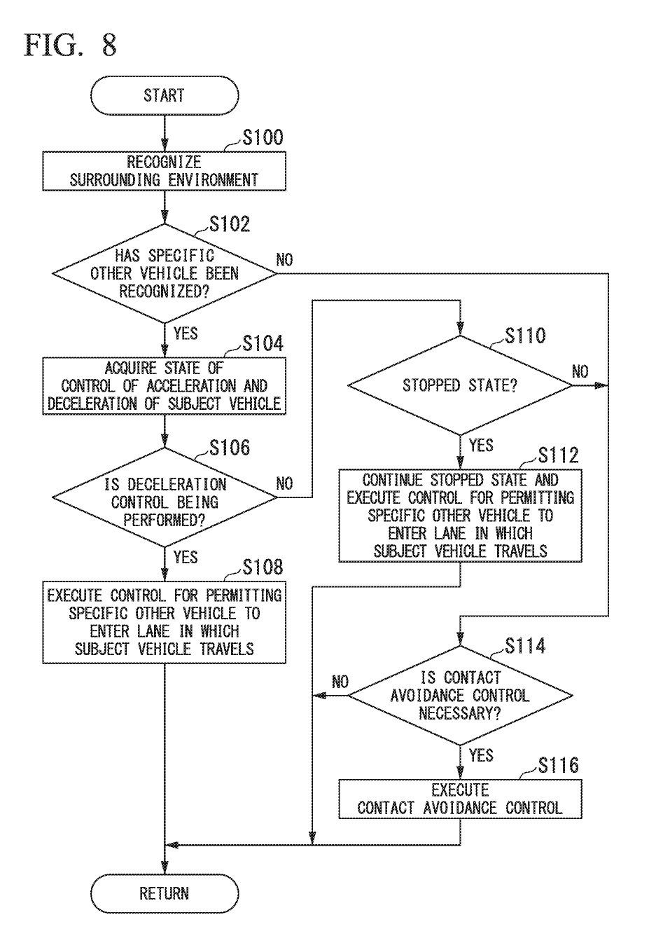

FIG. 8 is a flowchart showing the flow of a process to be executed by the automated driving control device 100 according to the embodiment. The process of this flowchart may be repeatedly executed at a predetermined cycle or predetermined timing, for example. At the time of start of this flowchart, it is assumed that a target trajectory is generated by the action plan generator 140, and automated driving control is executed by the second controller 160 according to the generated target trajectory.

In the example of FIG. 8, the surrounding environment recognizer 132 recognizes a surrounding environment of a road on which the subject vehicle M travels (step S100). Then, the specific other vehicle determiner 134 determines whether or not a specific other vehicle among the other vehicles recognized by the recognizer 130 has been recognized according to the surrounding environment recognized by the surrounding environment recognizer 132 (step S102). When it is determined that the specific other vehicle has been recognized, the entry permission controller 142 acquires a state of the acceleration and deceleration control of the subject vehicle M (step S104) and determines whether or not deceleration control is being performed (step S106). When it is determined that the deceleration control is being performed, the entry permission controller 142 executes control for permitting the specific other vehicle to enter the lane in which the subject vehicle M travels (step S108).

When it is determined that the deceleration control is not being performed in the process of step S106, the entry permission controller 142 determines whether or not the subject vehicle M is in a stopped state (step S110). When it is determined that the subject vehicle M is in the stopped state, the entry permission controller 142 continues the stopped state and executes the control for permitting the specific other vehicle to enter the lane in which the subject vehicle M travels (step S112). In the process of step S110, when it is determined that the subject vehicle M is not in a stopped state, the entry permission controller 142 does not execute the control for permitting the specific other vehicle to enter the lane in which the subject vehicle M travels. In this case, the avoidance driving controller 144 determines whether or not contact avoidance control between the subject vehicle M and surrounding objects is necessary according to a surrounding situation of the subject vehicle M recognized by the recognizer 130 (step S114). The process of step S114 is also executed, for example, when it is determined that the specific other vehicle is not recognized in the process of step S102.

When it is determined that the contact avoidance control is necessary, the avoidance driving controller 144 executes the contact avoidance control with the objects (step S116). Accordingly, this flowchart ends. In the process of step S114, the flowchart also ends when it is determined that the contact avoidance control is not necessary. According to the above-described embodiment, the automated driving control device 100 can cause the subject vehicle M travel more smoothly. Specifically, according to the embodiment, when the other vehicle present in front of the subject vehicle M and outside a road on which the subject vehicle M travels enters the road, the automated driving control device 100 can execute smoother traveling by executing driving control for permitting the other vehicle to enter the road according to an acceleration and deceleration control situation of the subject vehicle M.

The embodiment may be applied to control when another vehicle present in the lane L2 adjacent to the lane L1 in which the subject vehicle M travels or another vehicle present on the lane side opposite to the lanes L1 and L2 enters the lane L1 from the right side, instead of or in addition to a case in which the other vehicle enters from the area outside the lane to the left of the lane L1 of the subject vehicle M. In the embodiment, control regarding the entry of the other vehicle into the lane may be executed according to a control state of acceleration and deceleration in other travel controls, instead of or in addition to the control state of the acceleration and deceleration according to the following traveling control of the subject vehicle M.

[Hardware Configuration]

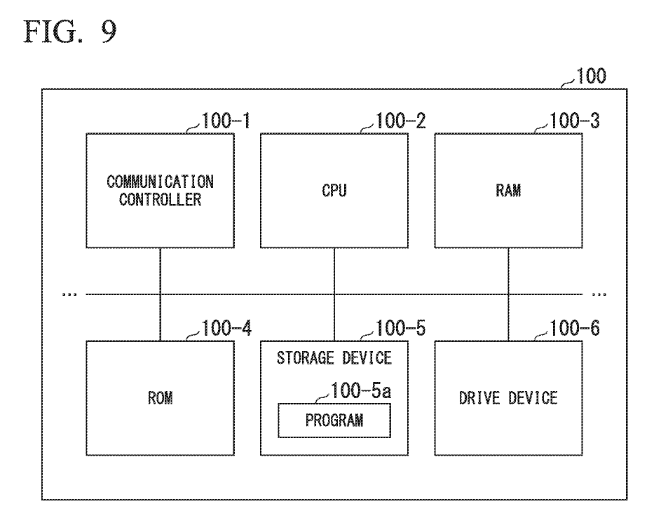

FIG. 9 is a diagram showing an example of a hardware configuration of the automated driving control device 100 according to the embodiment. As shown in FIG. 9, the automated driving control device 100 has a configuration in which a communication controller 100-1, a CPU 100-2, a RAM 100-3 that is used as a work memory, a ROM 100-4 that stores a boot program or the like, a storage device 100-5 such as a flash memory or an HDD, a drive device 100-6, and the like are connected to each other by an internal bus or a dedicated communication line. The communication controller 100-1 communicates with other components than the automated driving control device 100. A program 100-5a to be executed by the CPU 100-2 is stored in the storage device 100-5.

This program is developed in the RAM 100-3 by a direct memory access (DMA) controller (not shown) or the like and executed by the CPU 100-2. Accordingly, some or all of the first controller 120, the second controller 160, and the notification controller 180 of the automated driving control device 100 are realized.

The above-described embodiment can be represented as follows.

A vehicle control device including

a storage device that stores a program, and

a hardware processor,

wherein the hardware processor is configured to

recognize a surrounding situation of a subject vehicle;

control acceleration and deceleration and steering of the subject vehicle according to the recognized surrounding situation; and

determine whether or not the recognized other vehicle has entered a lane in which the subject vehicle travels, and execute driving control for permitting entry of the other vehicle according to a state of acceleration and deceleration control of the subject vehicle when it is determined that the other vehicle has entered the lane in which the subject vehicle travels, by executing the program stored in the storage device.

Although a mode for carrying out the present invention has been described above using the embodiment, the present invention is not limited to the embodiment at all, and various modifications and substitutions may be made without departing from the spirit of the present invention.

What is claimed is:

1. A vehicle control device comprising:
a recognizer that is configured to recognize a surrounding situation of a subject vehicle; and
a driving controller that is configured to control acceleration, deceleration and steering of the subject vehicle according to the surrounding situation recognized by the recognizer,
wherein the driving controller is configured to determine whether or not another vehicle recognized by the recognizer enters a lane in which the subject vehicle travels, and execute driving control for permitting entry of the other vehicle according to a state of acceleration and deceleration control of the subject vehicle when the driving controller determines that the other vehicle has entered the lane in which the subject vehicle travels.

2. The vehicle control device according to claim 1, wherein the driving controller is configured to execute driving control for permitting entry of the other vehicle when the recognizer recognizes the other vehicle entering the lane in which the subject vehicle travels during execution of the deceleration control of the subject vehicle.

3. The vehicle control device according to claim 2, wherein the deceleration control of the subject vehicle includes deceleration control according to following traveling control for following a preceding vehicle of the subject vehicle.

4. The vehicle control device according to claim 1, wherein, when the recognizer recognizes the other vehicle entering the lane in which the subject vehicle travels in a state in which the subject vehicle is stopped, the driving controller is configured to continue the stopped state.

5. The vehicle control device according to claim 1, wherein the driving controller is configured to determine that the other vehicle recognized by the recognizer enters the lane in which the subject vehicle travels, and is configured to not execute the driving control for permitting entry of the other vehicle when neither deceleration control nor stop control of the subject vehicle is executed.

6. A vehicle control method comprising:
recognizing, by a vehicle control device, a surrounding situation of a subject vehicle;
controlling, by the vehicle control device, acceleration, deceleration and steering of the subject vehicle according to the recognized surrounding situation; and
determining, by the vehicle control device, whether or not a recognized other vehicle has entered a lane in which the subject vehicle travels, and executing driving control for permitting entry of the other vehicle according to a state of acceleration and deceleration control of the subject vehicle when it is determined that the other vehicle has entered the lane in which the subject vehicle travels.

7. A computer readable non-transitory storage medium causing a vehicle control device to:
recognize a surrounding situation of a subject vehicle;
control acceleration, deceleration and steering of the subject vehicle according to the recognized surrounding situation; and
determine whether or not a recognized other vehicle has entered a lane in which the subject vehicle travels, and execute driving control for permitting entry of the other vehicle according to a state of acceleration and deceleration control of the subject vehicle when it is determined that the other vehicle has entered the lane in which the subject vehicle travels.
